(19) United States
(12) Patent Application Publication
(10) Pub. No.: US 2008/0262870 A1
(43) Pub. Date: Oct. 23, 2008

(54) Computerized Treatment Order and Associated Alert Processing System

(75) Inventors: Hilari K. Jones, Salt Lake City, UT (US); John K. Mayne, McCammon, ID (US); Michele A. Page, Salt Lake City, UT (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/104,875

(22) Filed: Apr. 17, 2008

Related U.S. Application Data
(60) Provisional application No. 60/912,488, filed on Apr. 18, 2007.

(51) Int. Cl. G06Q 50/00; G06F 17/30

(52) U.S. Cl. 705/2

(57) ABSTRACT

A system enables users to identify alert checking performed, identify treatment orders and allergies associated with alerts, link medications and allergies with alert descriptions, and preview pending results of various alert resolution actions. A computerized treatment order and associated alert processing system employs a repository including information identifying candidate treatments for order and associated corresponding related order parameters. A user interface processor uses information from the repository for providing data representing an alert preview single display image in response to user selection of candidate treatments for order. The single display image identifies multiple candidate treatment orders including multiple related order parameters as well as multiple alert messages indicating potential adverse health consequences to a particular patient from administering the multiple candidate treatments to the particular patient. The single display image also associates individual alert messages with candidate treatment orders enabling a user to identify individual alert messages associated with an individual treatment order of the multiple candidate treatment orders.

This is a non-provisional application of provisional application Ser. No. 60/912,488 filed Apr. 8, 2007, by H. K. Jones et al.

### FIELD OF THE INVENTION

This invention concerns a computerized treatment order and associated alert processing system enabling a user to identify individual alert messages associated with individual treatments of multiple candidate treatment orders.

### BACKGROUND OF THE INVENTION

Known patient treatment ordering systems identify alert conditions associated with medications ordered for a patient in a variety of ways, the most common of which utilizes a single pop-up window that indicates to a physician which medications have generated alert messages. FIGS. 1 and 2 illustrate how known systems present this information to the user. The display image of FIG. 1 employs red tabs 103 and 105 to indicate one or more alert messages have been generated in response to user entry of candidate order 107 into the known system. The display image of FIG. 2 employs red tabs 111, 113 and 115 to indicate one or more alert messages have been generated but there is no clear visible relationship between a user entered medication order and generated alert messages. In addition, the alerts associated with red tabs 111, 113 and 115 do not provide any detail regarding what a respective alert represents.

In known systems, detailed information regarding alert configuration is typically not presented to users while they are placing medication orders. Known systems typically have a file maintenance program that allows an authorized user to set the level of clinical checking for a hospital facility, for example, but this information is not displayed to the user during an order entry process. Further, known systems typically provide some information to the user regarding the alerts generated, but this is usually limited to an indication of either types of interactions (e.g., drug-allergy, therapeutic duplication) or just interactions (as illustrated in FIG. 2). Also, known systems typically provide some type of functionality that allows a user to select a medication and display associated alert messages in a secondary window. However, unless the user closes this window, it is difficult to tell which additional medications are linked to the alert. Because a given medication frequently generates not only more than one alert but also simultaneous alerts in conjunction with other medications, it is difficult in known systems to ascertain appropriate information required to resolve an alert. Typically, this results in physicians simply accepting alerts and not reading them in their entirety. Known CPOE (Computerized Physician Order Entry) systems typically inform a user in some manner that a medication cannot be checked for alerts. However, this information is generally displayed via a one-time popup message that does not indicate what types of alerts cannot be screened or which checks cannot be performed. Such messages cannot be viewed again after they are closed. The display image of FIG. 3 illustrates a known system single notification to a user that clinical checking cannot be performed.

Known systems typically present a single screen that lists interactions; however, it is difficult to ascertain which medication generated an alert. In addition, alert messages are not linked to a medication being ordered, making the information difficult to read when multiple alerts have been generated. Also, during an order entry process, known systems typically do not display information to a user about the extent of alert checking. This information is typically outlined in a file maintenance program, and unless the user knows how to access the file maintenance program and has security to view this information, it is impossible for the user to know how the clinical alert settings have been configured. Further, known systems typically limit presentation of alerts to those generated for medications being ordered. There is typically no detail regarding the alert and why it was generated, nor information regarding the alert severity level. In addition, alert information may not be directly linked to a specific alert message and the complete alert message may not be provided. Known systems provide information to the user when a medication cannot be checked; however, this is typically done via a one-time popup window that can no longer be accessed once closed and fails to provide any information regarding patient allergies that cannot be screened. A system according to invention principles addresses these deficiencies and related problems.

### SUMMARY OF THE INVENTION

A system comprehensively identifies and resolves clinical alerts generated concerning patient medication orders and patient allergies by enabling users to determine the extent of alert checking being performed, identify at a glance the orders and allergies for which alerts have been generated, cross-reference alerted medications and allergies with associated alert descriptions and preview pending results of alert resolution actions. A computerized treatment order and associated alert processing system employs a repository including information identifying candidate treatments for order and associated order parameters. A user interface processor uses information from the repository for providing data representing an alert preview single display image in response to user selection of candidate treatments for order. The single display image identifies multiple candidate treatment orders including multiple related order parameters as well as multiple alert messages indicating potential adverse health consequences to a particular patient from administering the multiple candidate treatments to the particular patient. The single display image also associates individual alert messages with candidate treatment orders, enabling a user to identify individual alert messages associated with an individual treatment order of the multiple candidate treatment orders.

### BRIEF DESCRIPTION OF THE DRAWING

FIGS. 1-3 show display image windows illustrating how known systems present alert conditions and alert checking status indications associated with medications ordered for a patient as used in prior art systems.

FIG. 4 shows a computerized treatment order and associated alert processing system, according to invention principles.

FIG. 5 shows a display image window indicating alert checking settings, according to invention principles.

FIG. 6 shows a display image window presenting an alert checking notice, according to invention principles.

FIGS. 7 and 8 show display image windows enabling a user to review selected orders and associated alert indications, according to invention principles.

FIG. 9 shows a display image window enabling a user to review alert indications, according to invention principles.

FIG. 10 shows a display image window identifying alert checking messages, according to invention principles.

FIG. 11 shows a display image window enabling a user to review alerts for an IV medication, according to invention principles.

FIG. 12 shows a display image window enabling a user to review overridden alerts and orders to be removed and preview effect on remaining alerts, according to invention principles.

FIG. 13 shows a display image window presenting an alert history, according to invention principles.

FIG. 14 shows a display image window presenting a global alert message history, according to invention principles.

FIG. 15 illustrates functional operation of a computerized treatment order and associated alert processing system, according to invention principles.

FIG. 16 shows a flowchart of a process performed by a system for providing data representing treatments for order for administration to a patient, according to invention principles.

### DETAILED DESCRIPTION OF THE INVENTION

A system according to invention principles comprehensively identifies and resolves clinical alerts generated concerning patient medication orders and patient allergies. The system promotes patient safety and reduces errors during computerized physician order entry by enabling users to determine the extent of alert checking being performed, identify at a glance the orders and allergies for which alerts have been generated, cross-reference alerted medications and allergies with the associated alert descriptions and preview pending results of various alert resolution actions. The system also logs information concerning orders removed and alerts overridden during the alert resolution process. The system enhances physician order entry workflow by streamlining alert processes, providing more detailed alert information and consolidating information into a presentable format easily interpreted by a physician.

The system identifies and resolves alerts during a computerized order entry workflow by enabling a hospital facility policy to determine the extent of alert checking being performed. This addresses the problem of displaying too many alerts (“alert noise”) as well as irrelevant, potentially clinically unimportant alerts, thereby decreasing the propensity for clinicians to “click through” alerts without paying attention to the detail. The system uses a cross-reference alert identifier that directly associates an alert to a specific medication or an allergy detail message and enables a user to see, at a glance, the settings used for alert generation. The system further identifies, in a single message, medications and allergies that cannot be checked for patient specific incompatibilities, drug interactions and duplications and appropriate dosage. The message information is available during the order entry process as well as an alert resolution process. The system uses alert sequence numbers to cross-reference alerted medications with associated alert descriptions. Thereby, a user is able to quickly identify medication interactions and make appropriate alert resolution decisions. The system also provides an alert resolution “preview” image window enabling a user to see a projected outcome of an alert resolution before a specified action is actually performed. This facilitates clinical workflow and decision-making by giving users a dynamic view of work remaining to resolve alerts.

In contrast, known systems typically fail to explicitly identify medications or allergies involved. Known systems also display a nonspecific warning to a user indicating that certain medications cannot be checked, and a user does not know what level of clinical checking has been set in the system and is unable to readily determine which alert has been generated for which medication or allergy.

A processor as used herein is a device and/or set of machine-readable instructions for performing tasks. A processor comprises any one or combination of hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A processor may be electrically coupled to any other processor enabling interaction and/or communication there between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a user interface processor and enabling user interaction with a processor or other device and associated data acquisition and processing functions.

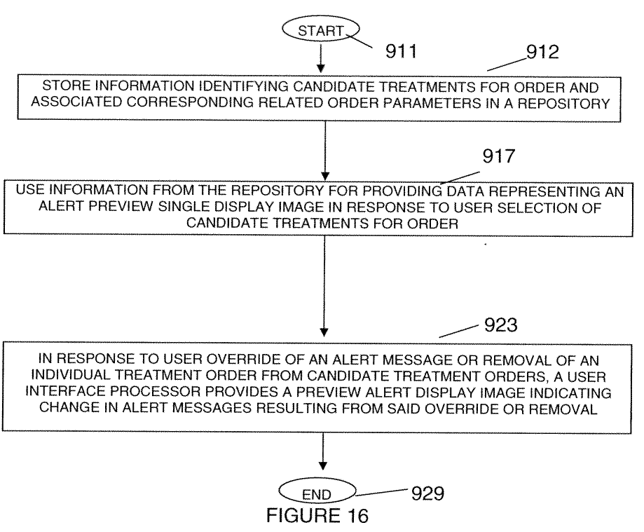

The UI also includes an executable procedure or executable application. The executable procedure or executable application conditions the user interface processor to generate signals representing the UI display images. These signals are supplied to a display device which displays the image for viewing by the user. The executable procedure or executable application further receives signals from user input devices, such as a keyboard, mouse, light pen, touch screen or any other means, allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps (e.g., of FIG. 16) herein may be performed automatically or wholly or partially in response to user commands. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

A workflow processor, as used herein, processes data to determine tasks to add to a task list or remove from a task list, or modifies tasks incorporated on, or for incorporation on, a task list. A task list is a list of tasks for performance by a worker or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition. The workflow engine includes a process definition function that allows users to define a process that is to be followed and includes an Event Monitor, which captures events occurring in a Healthcare Information System. A processor in the workflow engine tracks which processes are running for which patients, and what step needs to be executed next, according to a process definition, and includes a procedure for notifying clinicians of a task to be performed, through their worklists (task lists) and a procedure for allocating and assigning tasks to specific users or specific teams.

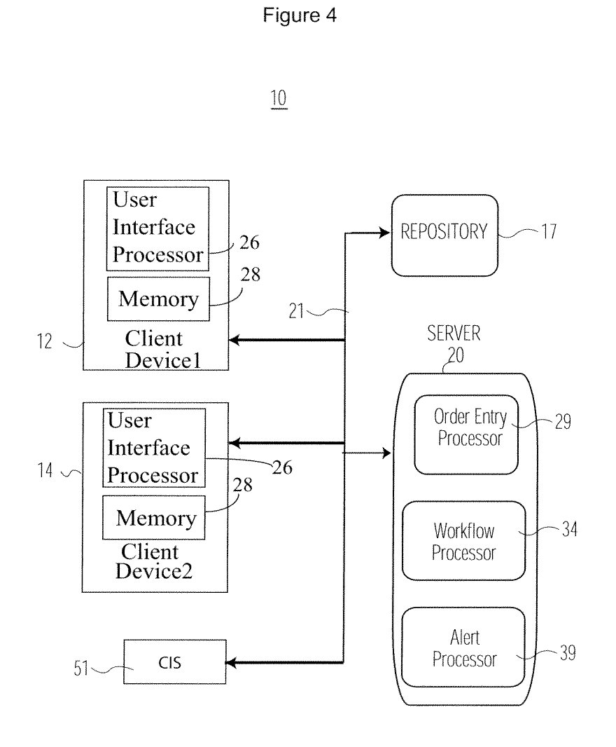

FIG. 4 shows computerized treatment order and associated alert processing system 10. System 10 includes processing devices (e.g., workstations or portable devices such as notebooks, Personal Digital Assistants, cell phones) 12 and 14, at least one repository 17, Clinical Information System Application (CIS) 51 and server 20, inter-communicating via network 21. Processing devices 12 and 14 individually include memory 28 and user interface processor 26. Server 20 includes order entry processor 29, alert processor 39 and workflow processor 34. User interface processor 26 presents one or more display images associated with execution of clinical information system 51 and order entry processor 29. Clinical information system 51 provides clinical application display images including an image identifying multiple different patients, for example. Order entry processor 29 enables a user to place orders for treatment (e.g., medication) to be administered to a patient selected via a clinical application display image, for example. Workflow processor 34 initiates, tracks, and monitors task sequences including administration of medications by nurses ordered using order entry processor 29, in response to events and generated alert messages. Workflow processor 34 also manages generation and distribution of alert messages.

Repository 17 includes information identifying candidate treatments for order and associated corresponding related order parameters. User interface processor 26 provides data representing display images for presentation on processing device 12 and 14. Specifically, user interface processor 26 uses information from repository 17 for providing data representing an alert preview single display image in response to user selection of candidate treatments for order. The single display image identifies multiple candidate treatment orders, including multiple related order parameters and multiple alert messages indicating potential adverse health consequences to a particular patient from administering the multiple candidate treatments to the particular patient. The single display image also associates individual alert messages with candidate treatment orders, enabling a user to identify individual alert messages associated with an individual treatment order of the multiple candidate treatment orders.

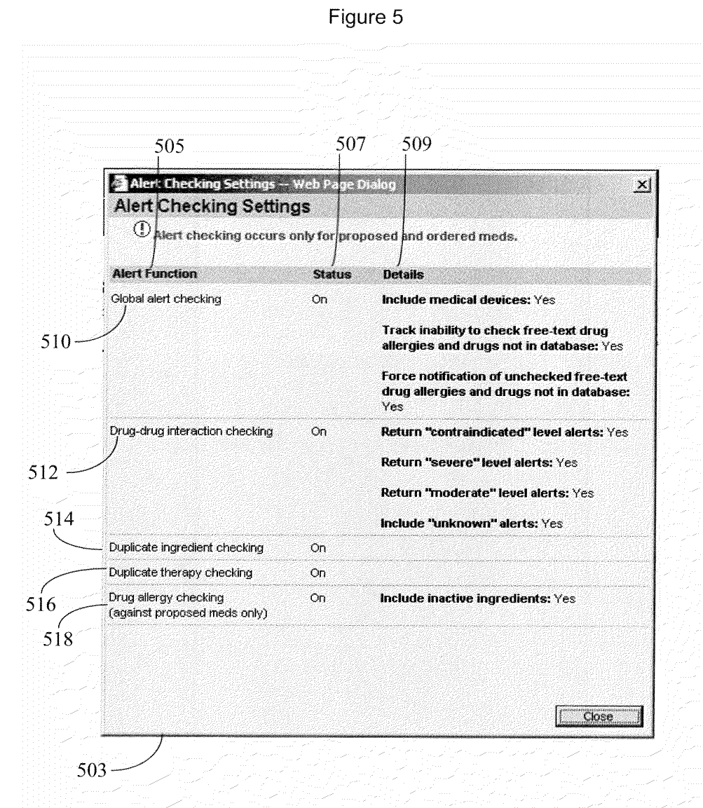

FIGS. 5-14 show display images provided by user interface processor 26 for display on workstation 12. Alert processor 39 performs alert checking for medications currently being ordered for a patient as well as for medications already on a patient order profile. In response to a user initially selecting orders and progressing to a Review Selected Orders detail display image, a displayed alert checking field indicates On or Off to identify whether alert checking of any type is enabled in a hospital facility. When facility alerts are enabled and at least one medication checking procedure (e.g., interaction, duplicate checking procedure) is being used, the field displays an On indication which is hyperlinked to an Alert Checking Settings popup window. FIG. 5 shows display image window 503 comprising alert checking settings pop-up window. Popup window 503 shows alert checking settings currently in use and identifies whether system 10 tracks drug allergies entered by a user in free-text or drugs not in the database that cannot be checked. The settings also identify whether a popup window identifying these allergies and drugs is displayed during order entry. Column 505 identifies alert functions and columns 507 and 509 indicate and associated corresponding On or Off status and description respectively. Popup window 503 indicates On or Off status of alert functions, including global alert checking 510, drug interaction checking 512, duplicate ingredient checking 514, duplicate therapy checking 516 and drug allergy checking 518 (for candidate order medications only), for example.

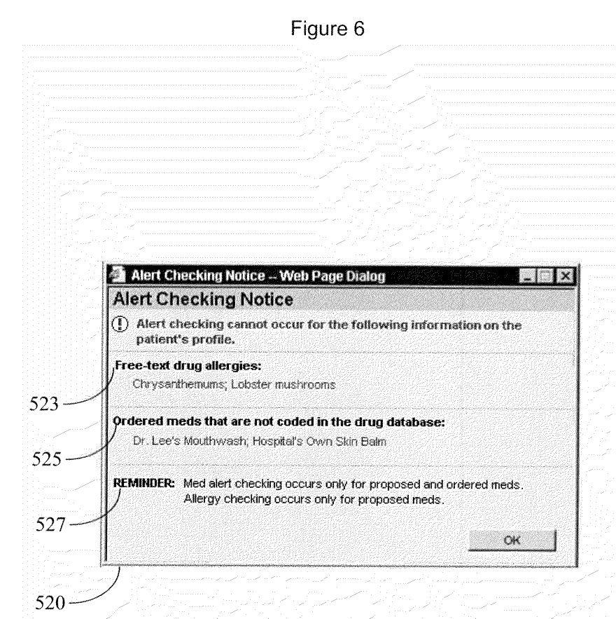

If a hospital (or other medical) facility has configured the alert system to notify users when free-text drug allergies or drugs not in the database cannot be checked, a popup alert checking notice window identifying the excluded allergies and drugs displays at the beginning of any order entry session that includes medications. FIG. 6 shows display image window 520 presenting an alert checking notice. Image window 520 identifies drug allergies 523 that are not checked for by the system, ordered medications 525 that are not in the drug database used and indicates reminder messages 527 indicating to a user what checking is performed on order medications.

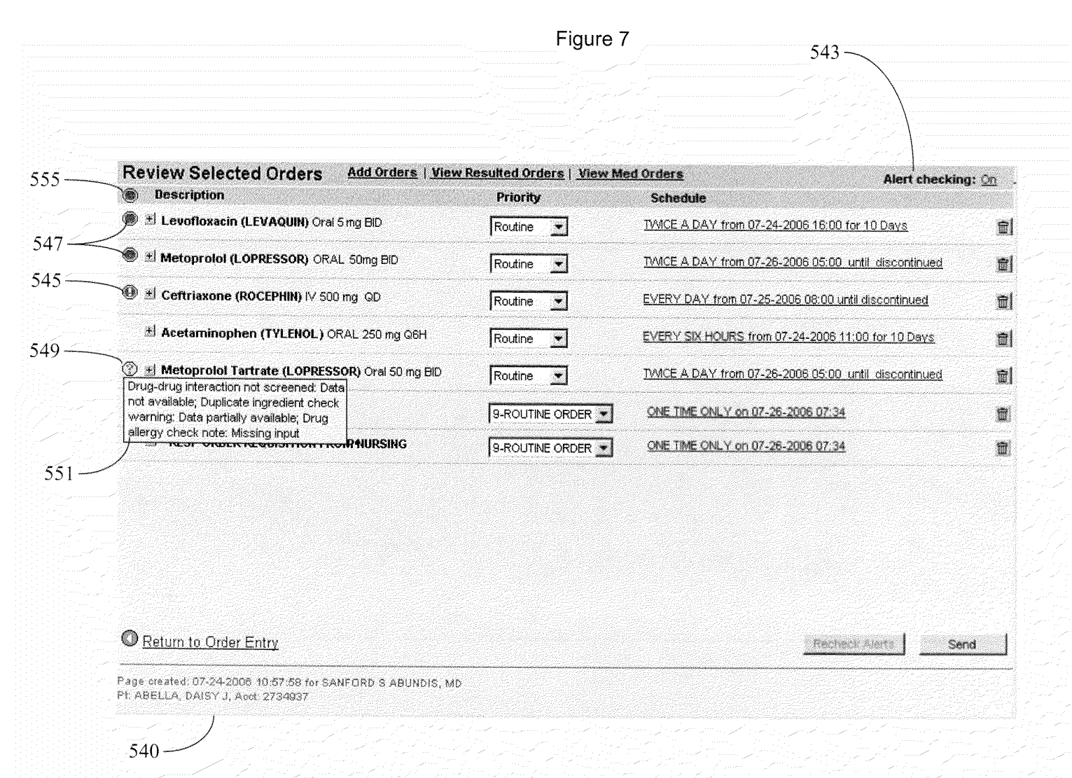

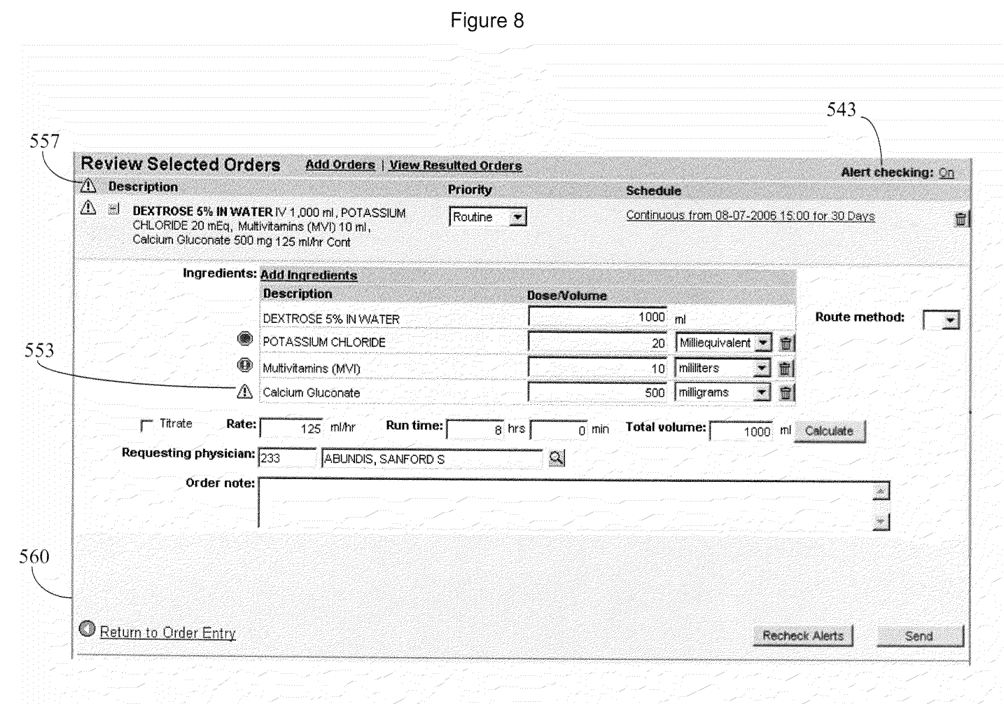

FIGS. 7 and 8 show display image windows 540 and 560 respectively, enabling a user to review selected orders and associated alert indications. If the Alert Checking Notice popup window 520 (FIG. 6) is generated during a medication order entry session using order entry processor 29, text (e.g., the hyperlinked term “with exceptions”) is appended to an Alert checking field 543 at the top of Review Selected Orders windows 540 (FIG. 7) and 560 (FIG. 8). The “exceptions” hyperlink allows a user to redisplay an Alert Checking Notice popup window 520 at any time during an ordering session. Further, in Review Selected Orders image windows 540 and 560, the system displays an icon next to any proposed medication order for which an alert message occurred. For IV (Intra-Venous) orders, an icon is presented adjacent to a complete order as well as adjacent to ingredient(s) that generated the alert message. Severe drug-drug interactions are indicated with a first icon 545, other interactions (non-severe drug-drug, drug-allergy, duplicate therapy, duplicate drug) are flagged with a second different icon 547. Also, hovering a cursor over an icon displays text identifying an alert message type. A third different icon 549 is displayed adjacent to an order or medication ingredient if alert checking could not be completed by alert processor 39 for a candidate medication order. Hover text 551 for the icon displays a summary of the conditions that prevented checking in response to a user superimposing a cursor over the icon or adjacent order.

Review Selected Orders windows 560 (FIG. 8) enables a user to add medication orders and ingredients to selected orders. A fourth different icon 553 indicates that alert checking has not yet occurred for a particular medication or, for IV and IVPB (Intra Venous Piggyback) medications or an ingredient in a medication. Further, Review Selected Orders windows 540 and 560 may be lengthy enough to require scrolling. Therefore, so that users are aware of an alert status of orders, an alert column header comprises a status indicator 555 (FIG. 7) and 557 (FIG. 8). Status indicator 555 (or 557) is empty (not valued) if no orders on a candidate order list generated alert messages. If all orders on a candidate list have been checked for alerts and one or more have an active alert, status indicator 555 (FIG. 7) comprises icon 547. If one or more orders on a candidate order list have not yet had alerts checked, status indicator 555 comprises icon 553. Further, if no active alerts were generated for all orders on a candidate order list, but one or more orders caused an alert checking failure or exclusion message, status indicator 555 comprises icon 549. If all orders on the page have been checked for alerts and all alerts have been resolved, status indicator 555 comprises a fifth different icon. In other embodiments the system uses other icons to identify the different types of alerts that are generated, such as drug-drug, drug-allergy, or dose range, for example.

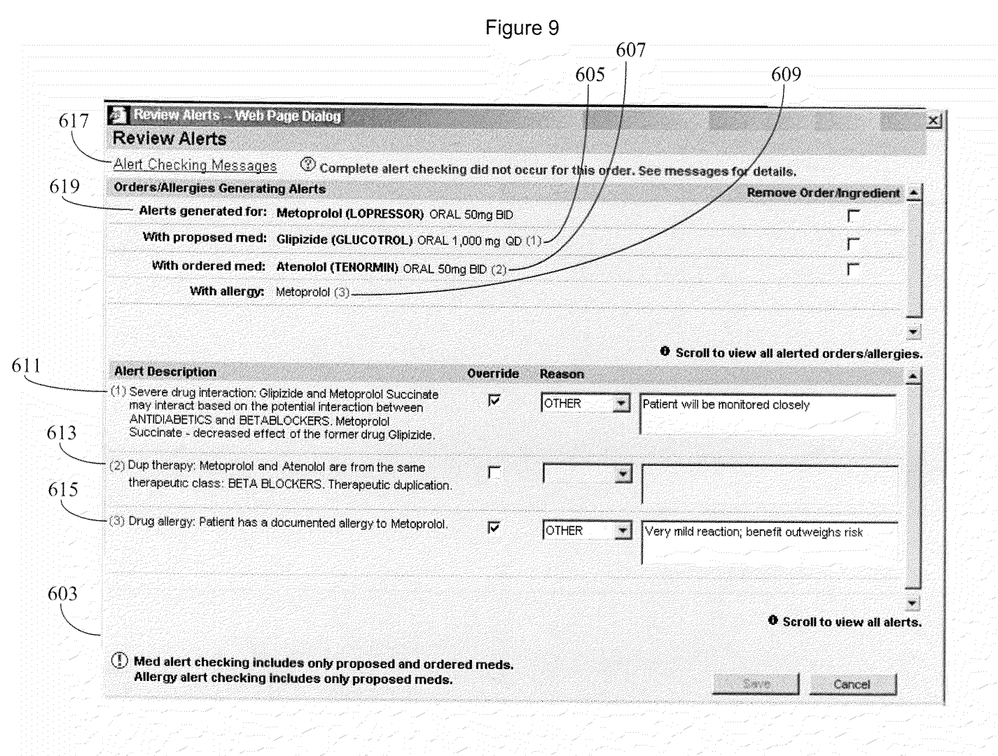

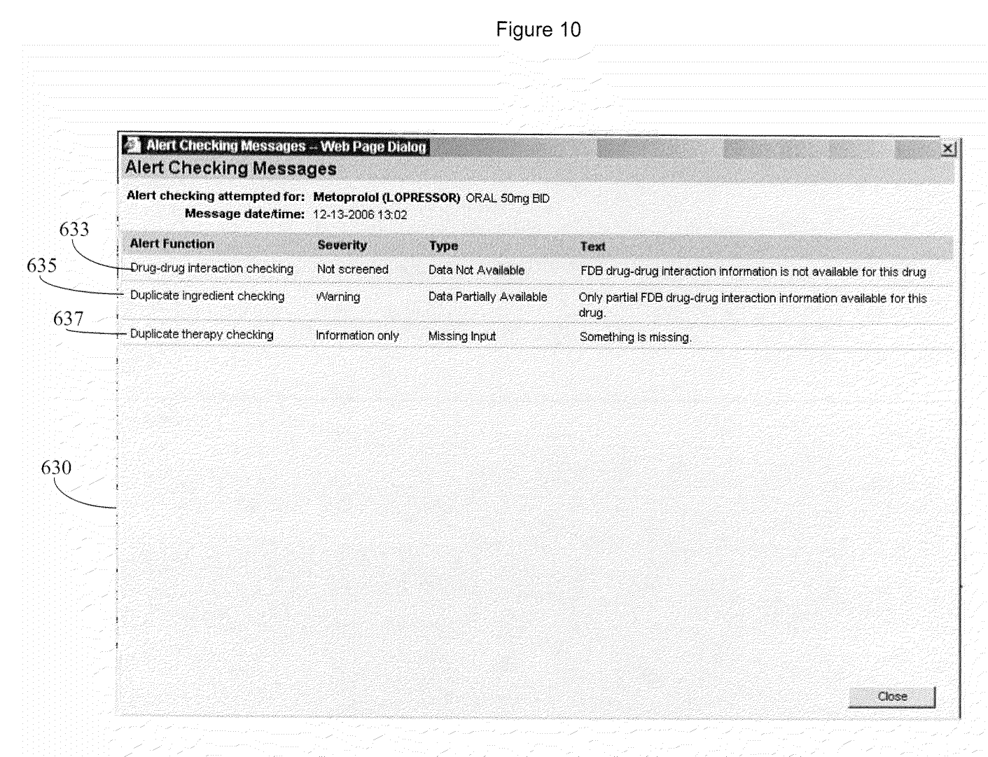

FIG. 9 shows display image window 603 enabling a user to review alert indications including failure or exclusion messages generated for a simple medication, for example. A user needs to resolve active alerts before orders can be placed. Clicking on an alert icon in Review Selected Orders screen 540 (FIG. 7) or 560 (FIG. 8) initiates display by user interface processor 26 of Review Alerts popup window 603 for a selected order. Alert information is displayed concerning a selected order and its relationship to other medication orders and order ingredients currently selected for placement (“candidate medications”), medication orders already on a patient profile (“ordered medications”), and codified patient allergies. Red numbers (e.g., 605, 607, 609) in parenthesis that follow an individual candidate medication or ingredient, ordered medication and allergy are alert sequence numbers that provide an easy way for a user to correlate an order or allergy having an associated alert message with an associated alert description (611, 613, 615) in a lower portion of image 603. If an alert checking failure or exclusion message was generated by alert processor 39, a warning message displays (e.g., 619) and Alert Checking Messages hyperlink 617 provides access to a popup window containing the messages. FIG. 10 shows display image window 630 identifying alert checking messages. Specifically, popup window 630 shows alert checking failure or exclusion messages indicating missing information including drug-drug interaction message 633, duplicate ingredient message 635 and duplicate therapy message 637.

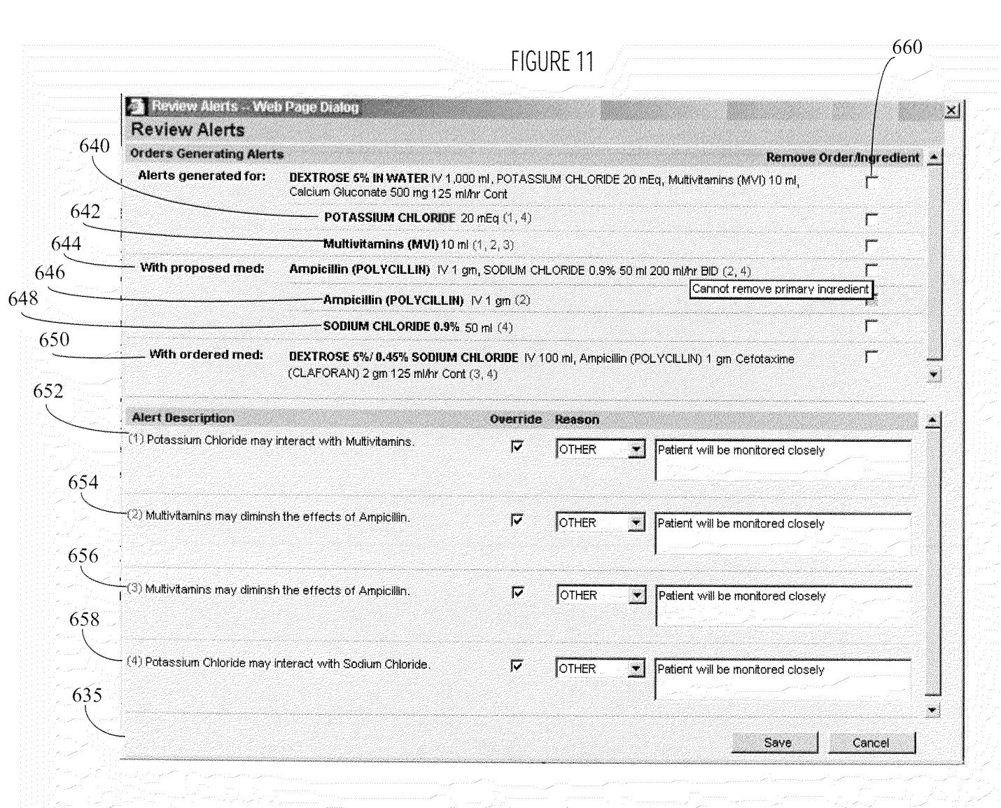

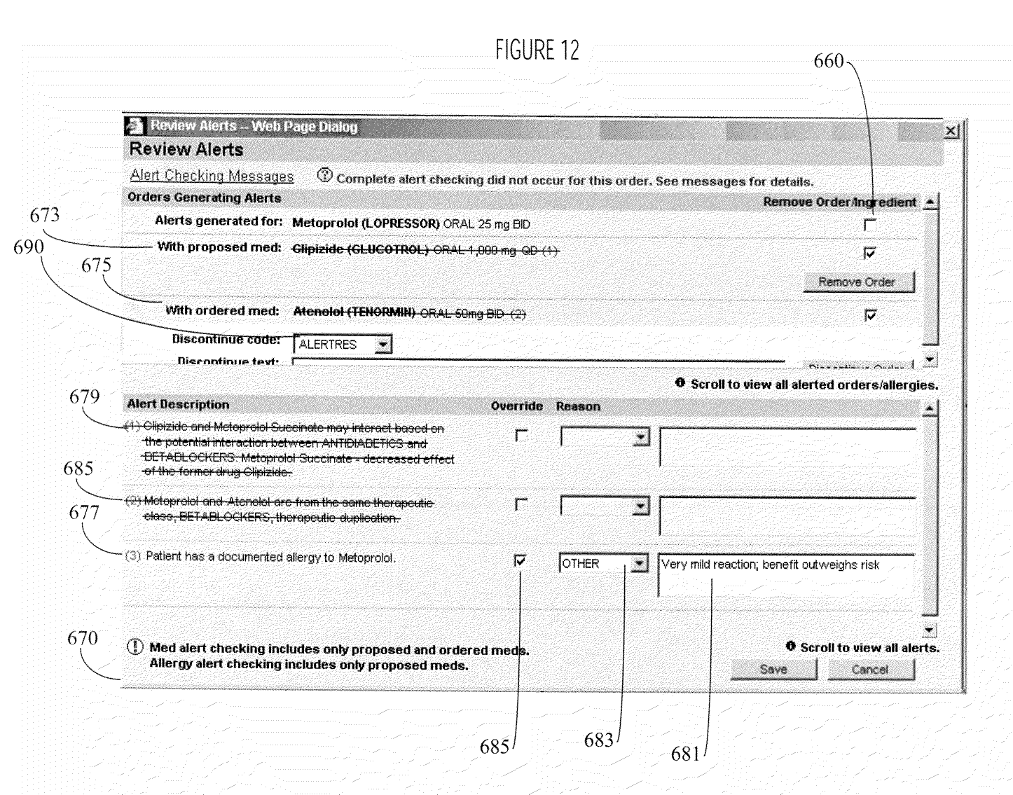

FIG. 11, similar to FIG. 10, shows display image window 635 enabling a user to review alerts for an IV medication. Specifically, image window 635 shows medication alerts 640, 642, 644, 646, 648 and 650 with corresponding alert descriptions 652, 654, 656 and 658. In order to resolve alerts, a user needs to either remove an order or ingredient or override an alert. A user selects candidate medications and ingredients to remove from an order “shopping cart” or ordered medications to cancel or discontinue in a patient profile by selecting Remove Order and Ingredient checkboxes in column 660. In response to a user selecting a medication or ingredient for removal, strikethrough text advantageously displays to give a preview of how removing a medication or ingredient will affect generated alert messages. FIG. 12 shows display image window 670 enabling a user to review overridden alerts and orders to be removed and preview the effect on the alerts. In response to a user removing a candidate medication, the medication is deleted from a shopping cart. For ordered medications, a user provides a cancellation or discontinuation code in box 690 and reason in an adjacent box, for which the order is canceled or discontinued in a patient profile. Orders 673 and 675 are indicated as removed by strikethrough text in response to user selection of corresponding removal boxes in column 660. Further, the system advantageously gives a preview of the effect of removing order items 673 and 675 on alert descriptions by indicating the effect with alert description strikethrough text items 679 and 685. A user overrides alerts, specifically alert 677 by selecting a corresponding override box in column 685 and, if required by a medical facility, selects or enters an override reason in boxes 681 and 683.

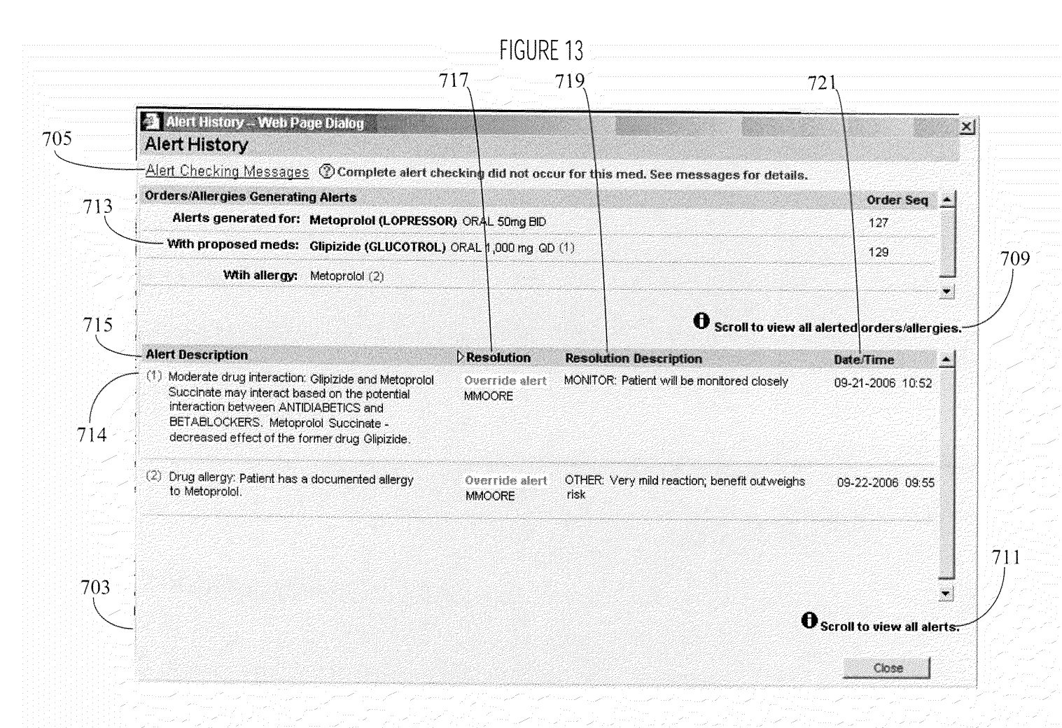

In response to a user resolving alerts for candidate orders, the orders are sent and alert resolution actions are recorded in repository 17 for display in an alert history record, which is accessible from anywhere in system 10 (FIG. 4). FIG. 13 shows display image window 703 presenting an alert history. If alert checking failure and exclusion messages are generated during order entry, alert history window 703 includes a link 705 to an alert message popup window (e.g., window 670 FIG. 12) that was available during order entry. In response to a user placing a medication order, if free-text drug allergies and/or non-codified drugs could not be analyzed for alerts, links 709 and 711 enable a user to access a global alert message history. Alert history image window 703 identifies alerts, e.g., alert 713 and corresponding alert descriptions in column 715, e.g., alert description 714. Alert descriptions in column 715 are associated with corresponding resolution action indicated in column 717, resolution description in column 719 and data/time in column 721.

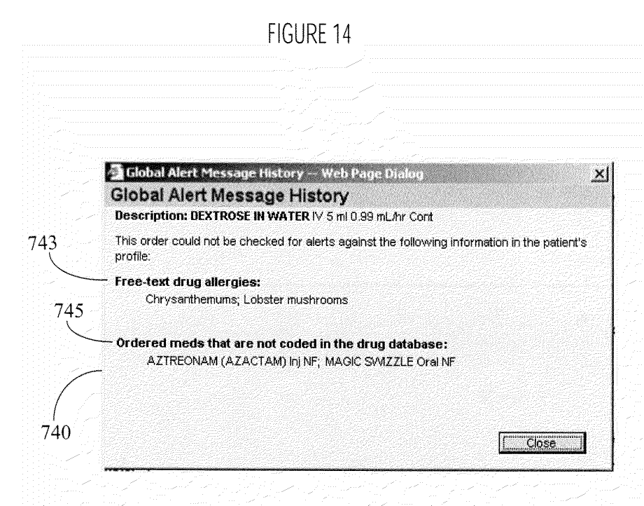

FIG. 14 shows display image window 740 presenting a global alert message history. Global Alert Message History window 740 presents information concerning free-text drug allergies 743 and non-codified medications that could not be checked for alerts when the specified medication order was placed 745.

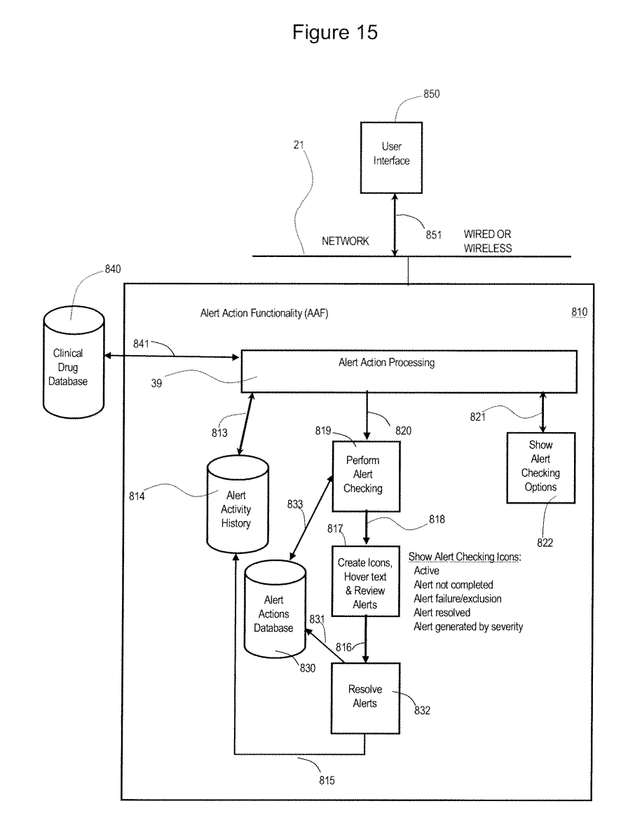

FIG. 15 illustrates functional operation of a computerized treatment order and associated alert processing system. A user selects a patient through a display image provided by user interface 850 and selects a Medication Ordering or a Medication Administration Record (MAR) function. In response to user selection of a medication for ordering to be administered to the patient, the Alert Action Function (AAF) 810 and alert processor 39 is initiated through interface 851 and (wired and/or wireless) network 21. Alert processor 39 initiates Performance of Alert Checking function 819 through interface 820 using Clinical Drug Database 840 accessed via interface 841. The actions to be initiated for each type of alert are obtained from the Alert Actions Database 830 through interface 833. AAF 810 creates icons, hover text and review alerts 817 in response to command from Performance of Alert Checking function 819 through interface 818 and information acquired from the Alert Actions Database 830 through interface 831. The active alert checking icons displayed include, Active alert (no severity), Alert not completed, Alert failure or exclusion, Alert resolved and Active alert generated by severity. Show Alert Checking options 822 are displayed in a display image provided by user interface 850 through interfaces 851 and 821.

Resolve Alerts function 832 prompts a user to remove medications from a candidate medications order list or override an alert in response to detection of a generated alert message and records data indicating actions taken in Alert Activity History database 814 through interface 815. Further, Resolve Alerts function 832 queries Alert Action Database 830 to determine Alert resolution actions that are to be initiated for individual alert types. Data indicating activities performed by AAF 810 are recorded in Alert Activity History database 814 through interface 813. Alert Activity History database 814 facilitates satisfying requirements of Health Insurance Portability and Accountability Act (HIPAA).

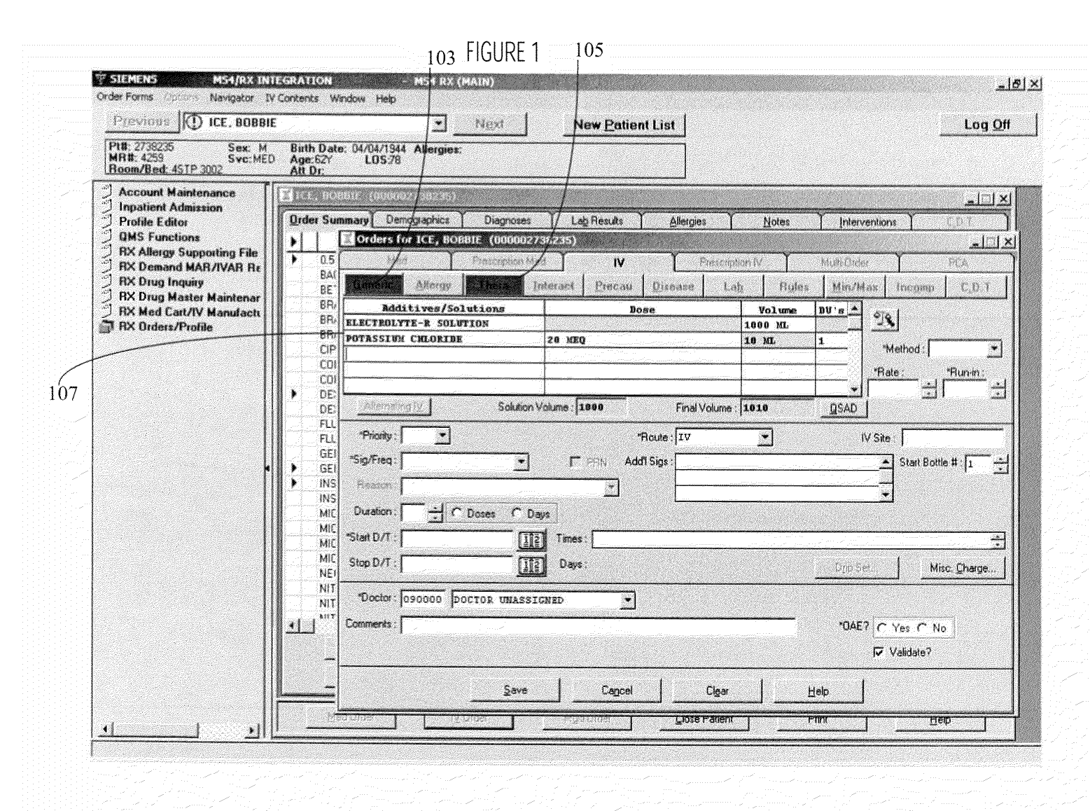

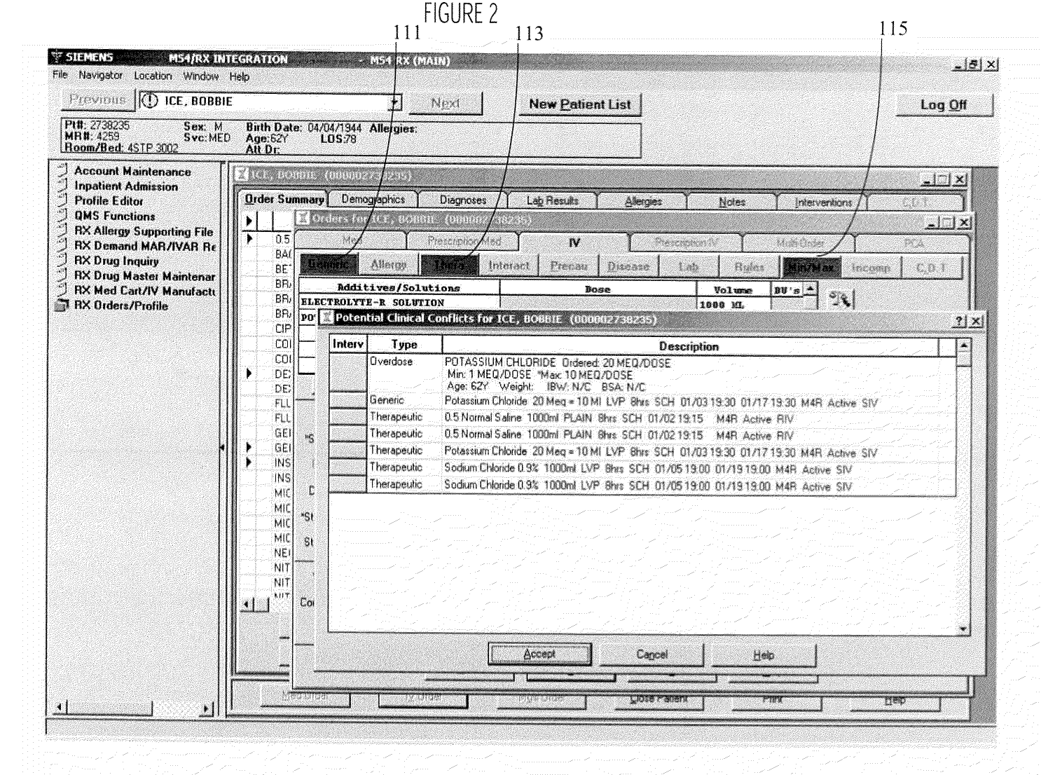

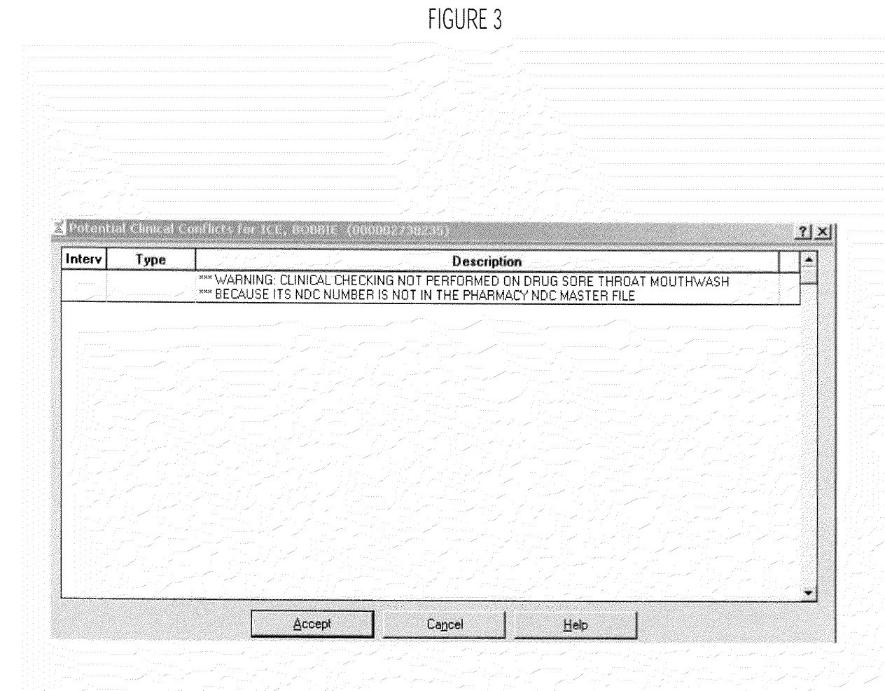

The system directly associates alert messages generated with one or more particular medications or drug allergies in repository 17 (FIG. 1) and provides a detailed message concerning a specific medication interaction, for example. The system also enables a user to identify medications and drug allergies that cannot be screened and to identify clinical applications for which medications or drug allergies cannot be screened. A user is able to view this information multiple times, in abbreviated hover-text format in a Review Selected Orders image display and in detailed full-text format in a Review Alerts image window. Further, the system enables a user to view clinical interaction settings in use without navigating away from a Review Selected Orders image window, in response to a single command (e.g., mouse click).

FIG. 16 shows a flowchart of a process performed by system 10 (FIG. 4) for providing data representing treatments for order for administration to a patient. In step 912 following the start at step 911, system 10 stores information in repository 17 identifying candidate treatments for order and associated corresponding related order parameters. User interface processor 26, in step 917, uses information from repository 17 for providing data representing an alert preview single display image in response to user selection of candidate treatments for order. The single display image identifies multiple candidate treatment orders, including multiple related order parameters and identifies multiple alert messages indicating potential adverse health consequences to a particular patient from administering the multiple candidate treatments to the particular patient. The single display image associates individual alert messages with candidate treatment orders enabling a user to identify individual alert messages associated with an individual treatment order of the multiple candidate treatment orders. In step 923, in response to user override of an alert message or removal of an individual treatment order from the multiple candidate treatment orders, user interface processor 26 automatically provides a preview alert display image indicating change in alert messages resulting from the override or removal.

The single display image associates first and second different alert messages of the multiple individual alert messages with an individual single treatment order of the multiple candidate treatment orders, enabling a user to identify the first and second different alert messages as being associated with the individual single treatment order. The single display image enables a user to override an alert message or remove an individual treatment order from the multiple candidate treatment orders. The preview alert display image indicates the change in alert messages by indicating deletion of no longer applicable alert messages, and the preview alert display image indicates deletion of no longer applicable alert messages by at least one of, (a) strikethrough marking, (b) cross-out marking and (c) highlighting.

User interface processor 26 associates individual alert messages with candidate treatment orders by using dynamic alert message identifiers that individually identify corresponding different individual alert messages and by associating a particular alert message identifier with corresponding individual treatment orders at least partially responsible for occurrence of the particular alert message. The dynamic alert message identifiers are dynamically revalued in response to a user at least one of, (a) overriding an alert message and (b) removing an individual treatment order from the multiple candidate treatment orders. An alert message indicates a condition of clinical significance comprising at least one of (a) medication interaction, (b) a therapeutic duplicate medication, (c) inappropriate dosage, (d) a patient specific medication allergy, and (e) an inability to perform a medication patient compatibility screening. The alert message provides a detailed description of the condition of clinical significance. Further, the related order parameters identify at least one of (a) quantity, (b) a route of administration of a medical treatment, (c) a frequency of administering a treatment, and (d) a form of medical treatment. The form of medical treatment comprises a package type, a strength of a medical treatment or a concentration of a medical treatment. Also, the single display image includes image elements indicating a severity level associated with the alert messages indicating potential adverse health consequences to the particular patient. The single display image includes a particular alert message and indicates the particular alert message is associated with a particular candidate treatment order, and the particular alert message indicates an inability to determine a medication is suitable for the particular patient in response to an absence of information.

Further, the particular alert message indicates the absence of information and concerns patient specific information or medication related information and is displayed in response to a cursor hover action. User interface processor 26 provides data representing the single display image window. In addition, the single display image includes a user selectable image element for initiating display of an image window indicating treatment evaluation settings used in identifying the potential adverse health consequences to the particular patient from administering the multiple candidate treatments to the particular patient. The process of FIG. 16 terminates at step 929.

The systems and processes of FIGS. 4-16 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The alert checking process may be used in any system for which automated rules about order entry restrictions and requirements are defined; for example, an inventory ordering system. This system is of particular use by physicians who have the clinical knowledge to resolve alerts and need an efficient means of doing so. The processes and applications may, in alternative embodiments, be located on one or more (e.g., distributed) processing devices accessing a network linking the elements of FIG. 4. Further, any of the functions and steps provided in FIGS. 4-16 may be implemented in hardware, software or a combination of both and may reside on one or more processing devices located at any location of a network linking the elements of FIG. 4 or another linked network, including the Internet.

What is claimed is:

1. A computerized treatment order and associated alert processing system, comprising:
a repository including information identifying candidate treatments for order and associated corresponding related order parameters; and
a user interface processor, electrically coupled to said repository, for using information from said repository for providing data representing an alert preview single display image in response to user selection of candidate treatments for order, said single display image,
identifying a plurality of candidate treatment orders including a plurality of related order parameters,
identifying a plurality of alert messages indicating potential adverse health consequences to a particular patient from administering said plurality of candidate treatments to said particular patient and
associating individual alert messages with candidate treatment orders enabling a user to identify individual alert messages associated with an individual treatment order of said plurality of candidate treatment orders.

2. A system according to claim 1, wherein
said single display image associates first and second different alert messages of said plurality of individual alert messages with an individual single treatment order of said plurality of candidate treatment orders enabling a user to identify said first and second different alert messages as being associated with said individual single treatment order.

3. A system according to claim 2, wherein
said single display image enables a user to at least one of, (a) override an alert message and (b) remove an individual treatment order from said plurality of candidate treatment orders.

4. A system according to claim 3, wherein
in response to user override of an alert message or removal of an individual treatment order from said plurality of candidate treatment orders said user interface processor provides a preview alert display image indicating change in alert messages resulting from said override or removal.

5. A system according to claim 4, wherein
said preview alert display image indicates said change in alert messages by indicating deletion of no longer applicable alert messages.

6. A system according to claim 5, wherein
said preview alert display image indicates deletion of no longer applicable alert messages by at least one of, (a) strikethrough marking, (b) cross-out marking and (c) highlighting.

7. A system according to claim 1, wherein
said user interface processor associates individual alert messages with candidate treatment orders using dynamic alert message identifiers individually identifying corresponding different individual alert messages and by associating a particular alert message identifier with corresponding individual treatment orders at least partially responsible for occurrence of said particular alert message.

8. A system according to claim 7, wherein
said dynamic alert message identifiers are dynamically revalued in response to a user at least one of, (a) overriding an alert message and (b) removing an individual treatment order from said plurality of candidate treatment orders.

9. A system according to claim 1, wherein
an alert message indicates a condition of clinical significance comprising at least one of, (a) medication interaction, (b) a therapeutic duplicate medication, (c) inappropriate dosage, (d) a patient specific medication allergy and (e) an inability to perform a medication patient compatibility screening.

10. A system according to claim 9, wherein
said alert message provides a detailed description of said condition of clinical significance.

11. A system according to claim 1, wherein
said related order parameters identify at least one of, (a) quantity, (b) a route of administration of a medical treatment, (c) a frequency of administering a treatment and (d) a form of medical treatment.

12. A system according to claim 6, wherein
said form of medical treatment comprises at least one of, (a) a package type, (b) a strength of a medical treatment and (c) a concentration of a medical treatment.

13. A system according to claim 1, wherein
said single display image includes image elements indicating a severity level associated with said alert messages indicating potential adverse health consequences to said particular patient.

14. A system according to claim 1, wherein
said single display image includes a particular alert message and indicates said particular alert message is associated with a particular candidate treatment order and said particular alert message indicates an inability to determine a medication is suitable for said particular patient in response to an absence of information.

15. A system according to claim 14, wherein
said particular alert message indicates said absence of information and concerns at least one of, (a) patient specific information and (b) medication related information.

16. A system according to claim 14, wherein
said particular alert message is displayed in response to a cursor hover action.

17. A system according to claim 1, wherein
said user interface processor provides data representing an image window including a particular alert message and indicates said particular alert message is associated with a particular candidate treatment order and said particular alert message indicates an inability to determine a medication is suitable for said particular patient in response to an absence of information.

18. A system according to claim 1, wherein
said single display image includes a user selectable image element for initiating display of an image window indicating treatment evaluation settings used in identifying said potential adverse health consequences to said particular patient from administering said plurality of candidate treatments to said particular patient.

19. A computerized treatment order and associated alert processing system, comprising:
a repository including information identifying candidate treatments for order and associated corresponding related order parameters; and
a user interface processor, electrically coupled to said repository, for using information from said repository for providing data representing an alert preview single display image in response to user selection of candidate treatments for order, said single display image,
identifying a plurality of candidate treatment orders including a plurality of related order parameters,
identifying a plurality of alert messages indicating potential adverse health consequences to a particular patient from administering said plurality of candidate treatments to said particular patient and
associating individual alert messages with candidate treatment orders enabling a user to identify individual alert messages associated with an individual treatment order of said plurality of candidate treatment orders and in response to user override of an alert message or removal of an individual treatment order from said plurality of candidate treatment orders said user interface processor automatically provides a preview alert display image indicating change in alert messages resulting from said override or removal.
